(19) United States
(12) Patent Application Publication
(10) Pub. No.: US 2026/0111347 A1
(43) Pub. Date: Apr. 23, 2026

(54) GENERATION OF MOCK OBJECTS FOR INTEGRATION TESTING

(71) Applicant: SAP SE, Walldorf (DE)

(72) Inventors: Andreas Jahr, Karlsruhe (DE); Wulf Kruempelmann, Altlussheim (DE)

(21) Appl. No.: 18/921,737

(22) Filed: Oct. 21, 2024

(51) Int. Cl. G06F 11/36; G06F 9/54

(52) U.S. Cl. CPC G06F 11/3684; G06F 9/547; G06F 11/3688

(57) ABSTRACT

Arrangements for the generation of mock objects for integration testing are provided. An application programming interface (API) package may be received and an API server implementation may be generated based on the API package. The API package may be tokenized. API test cases and associated API output data may be received. A denormalized test case may be generated by replacing variables and constants by their values. Using the API server implementation, language-independent server methods describing behavior of atomic activities of a mock server may be generated based on the tokenized API package and the denormalized test case. A mock service template indicating an execution structure of a mock service may be received. The mock service may be generated using the mock service template and the generated language-independent server methods. The mock service may be verified by executing the API test cases against the mock service.

### TECHNICAL FIELD

The subject matter described herein relates generally to data processing and, in particular, to generation of mock objects for integration testing.

### BACKGROUND

Integration testing is often difficult since both tenants need to be set up synchronously according to business processes and service versions. A working test requirement often requires high set up effort, requiring fully configured tenants, repetition of tests may require repetition of set up, and both sides require matching test data. Other difficulties include a high alignment effort to synchronize business processes and service delivery, a high cost of understanding since both sides of the integration often have different terminologies such as for inbound and outbound application programming interfaces, and a high effort to update and enhance integration test cases to reflect integration changes introduced by a service development.

### SUMMARY

Methods, systems, and articles of manufacture, including computer program products, are provided for generation of mock objects for integration testing are implemented. In one aspect, a computer-implemented method includes: receiving an application programming interface (API) package, wherein the API package comprises description data in machine-readable structure corresponding to APIs that are subject to an integration; generating an API server implementation based on the API package; tokenizing the API package, wherein the tokenizing comprises identifying, in a structured manner, method calls, input parameters, and output parameters; receiving API test cases and associated API output data; generating a denormalized test case by replacing variables and constants by their values; generating, using the API server implementation, language-independent server methods describing behavior of atomic activities of a mock server based on the tokenized API package and the denormalized test case; receiving a mock service template indicating an execution structure of a mock service; generating the mock service using the mock service template and the generated language-independent server methods; and verifying the mock service by executing the API test cases against the mock service.

In some variations one or more of the following can optionally be included. The API output data includes API call responses persisted to a file. The API test cases include test code in a programming language. The API test cases are developed locally via a local test setup for individual testing of an API exposed by a service. The mock service template includes structure and configurations of a mock service at runtime. The method may further include generating an integration client in a target programming language matching the generated mock service, and verifying the integration client by testing the integration client against an original service. The method may further include modifying the mock service by adjusting configurations of programs or prompts.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an illustrative computing environment of a system for generation of mock objects for integration testing in accordance with some example embodiments;

FIG. 1B depicts an illustrative computing environment of a system for generation of mock objects for integration testing in accordance with some example embodiments;

FIG. 1C depicts an illustrative computing environment of a system for generation of mock objects for integration testing in accordance with some example embodiments;

FIG. 2 depicts an illustrative computing environment of a system for generation of mock objects for integration testing in accordance with some example embodiments;

FIG. 3 depicts a flowchart illustrating a process for implementing generation of mock objects for integration testing in accordance with some example embodiments;

FIG. 4 depicts a flowchart illustrating a process for implementing generation of mock objects for integration testing in accordance with some example embodiments;

FIGS. 5A-5B depict a detailed flowchart illustrating a process for implementing generation of mock objects for integration testing in accordance with some example embodiments; and

FIG. 6 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with integration testing between productive services. Aspects of the disclosure generates a mock server from local API test cases that allow for fully testing an integration locally by using the mock server on a communication partner which is not subject to test. Among other advantages, aspects of the disclosure provide significantly reduced test setup effort and reduced complexity. No synchronization (releases, test data structures, authorizations, etc.) with an integration partner is needed. The mock server itself synchronizes the releases and reacts on possible changes. Additional aspects of the disclosure provide reduced need for joint and up-to-date test landscapes. Further aspects of the disclosure provide easy-to-conduct compatibility and smoke tests on integration by customers in customer production and test tenants. Additionally, mock services may be generated based on unit tests.

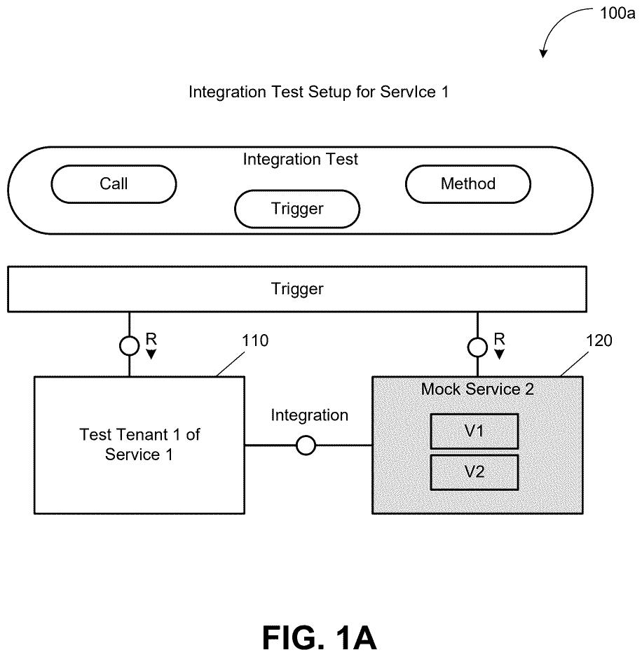

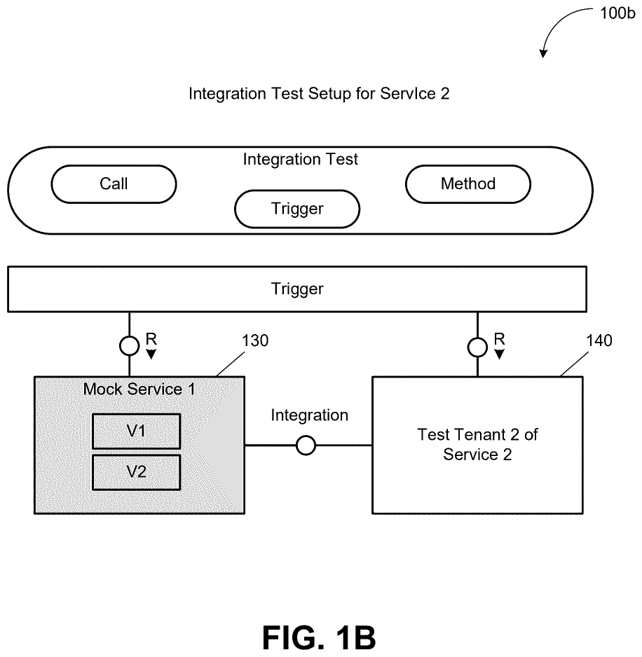

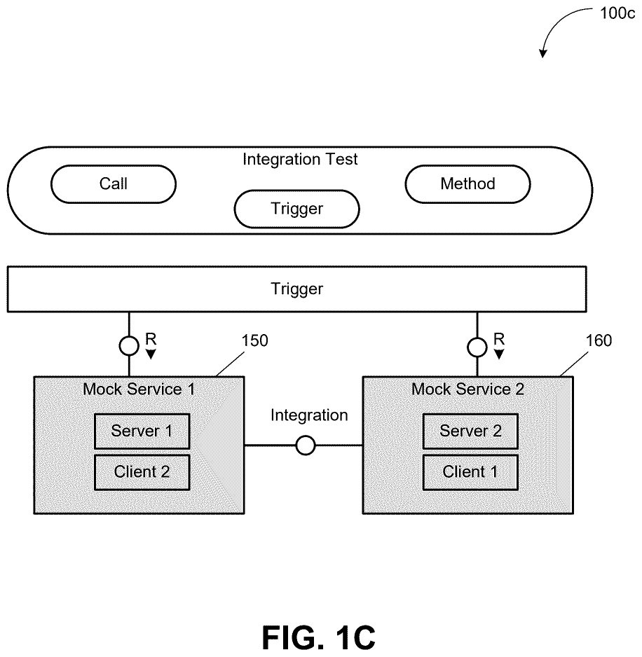

FIG. 1A depicts an illustrative computing environment 100a of a system for generation of mock objects for integration testing in accordance with some example embodiments. As shown in FIG. 1A, a developer of service 1 might want to check whether the integration they prepared with its APIs and clients work against service 2. Instead of having to set up service 2 entirely, a mock service 2 (120) may be provided. As shown in FIG. 1A, an integration test may be set up and executed from the perspective of service 1 (110). The test covers service 1 API calls to service 2. The running mock server container (i.e., mock service 2 (120)) offers the current and the previous release version of partner service 2. The integration test may be executed against the version 1 (V1) or version (V2) in order to check service 1 client compatibility. Advantageously, instead of running the integration test against two live instances, the integration test may be performed locally in a user's own test environment.

A mock service may be used in different test scenarios. For example, FIG. 1B depicts an illustrative computing environment 100b of a system for generation of mock objects for integration testing in accordance with some example embodiments. FIG. 1C depicts another illustrative computing environment 100c of a system for generation of mock objects for integration testing in accordance with some example embodiments. More specifically, FIG. 1B illustrates a symmetric setup of FIG. 1A from the perspective of service 2 (140). By providing the old and the new API version (i.e., V1 and V2) in the mock service (130), it is possible to test compatibility of the existing service 1. In some configurations, referring to FIG. 1C, mock services may run against each other. FIG. 1C illustrates mocks of entire services participating in an integration. As shown in FIG. 1C, mock service 1 (150) includes server 1 (mock server of service 1) and client 2 (client for service 2), and mock service 2 (160) includes server 2 (mock server of service 2) and client 1 (client for service 1). This arrangement allows for preparing integration tests, and for testing of whether mock services are compatible and whether integration tests work as intended. Additionally or alternatively, in some embodiments, the mock server may be embedded into a service implementation (e.g., a test or productive service) for testing technical connectivity of a service version without having a service under test fully configured for successful API calls. Additionally or alternatively, in some embodiments, the mock service may be embedded in productive tenants, allowing customers to check their compatibility of a newly upgraded tenant with already existing services.

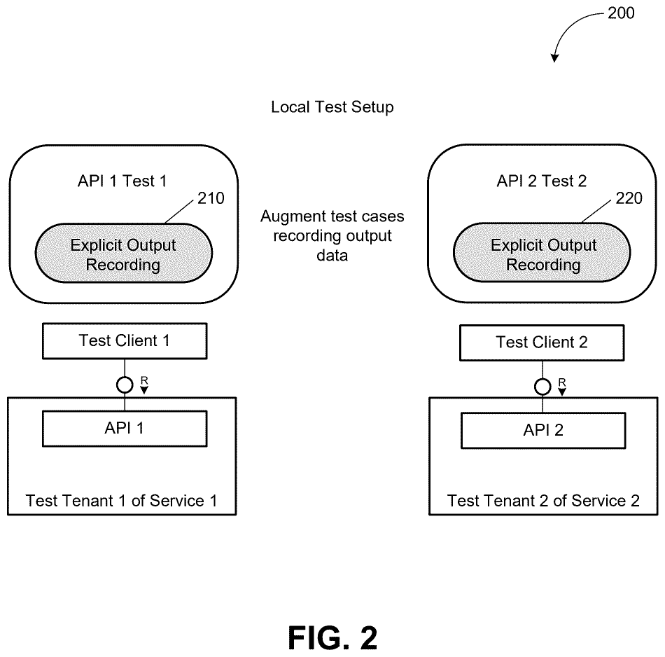

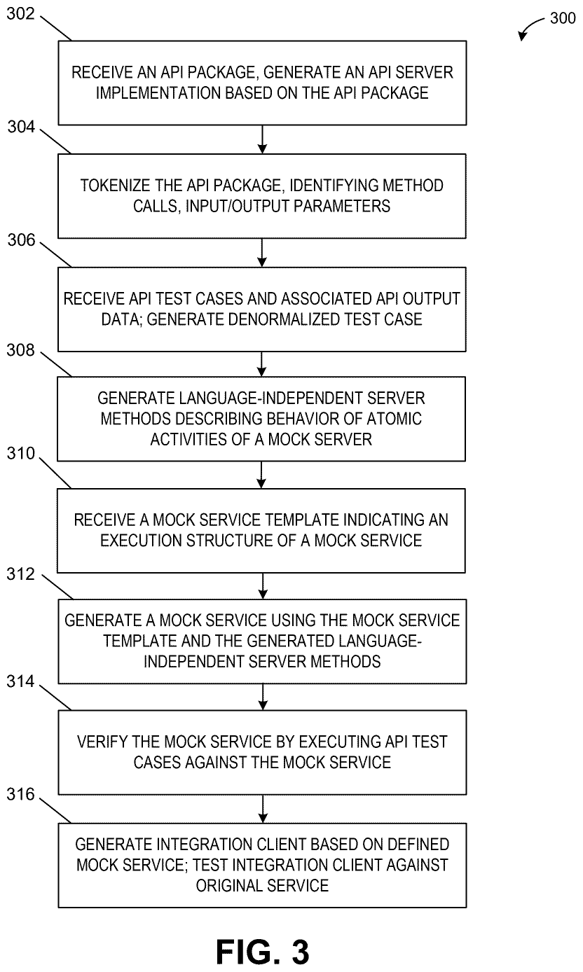

FIG. 2 depicts an illustrative computing environment 200 of a system for generation of mock objects for integration testing in accordance with some example embodiments. FIG. 3 depicts a flowchart illustrating a process 300 for implementing generation of mock objects for integration testing in accordance with some example embodiments. FIGS. 2 and 3 will be discussed together. Referring to FIG. 3, at step 302, a computing platform may receive (read) an application programming interface (API) package. The API package may include description data in machine-readable structure corresponding to APIs that are subject to an integration. In addition, an API server implementation may be generated based on the API package.

At step 304, the computing platform may tokenize the API package. Tokenizing may include identifying, in a structured manner, method calls, input parameters, and output parameters.

At step 306, the computing platform may receive API test cases and associated API output data. In addition, the computing platform may generate a denormalized test case by replacing variables and constants by their values. The API test cases may include test code in a programming language. In some examples, the API test cases are developed locally via a local test setup for individual testing of an API exposed by a service. The API output data may include API call responses persisted to a file. In this regard, FIG. 2 illustrates augmenting test cases by recording exact output data at 210, 220. This is in addition to hard-coded input test data and allows for creating even more realistic mock services.

Returning to FIG. 3, at step 308, the computing platform may generate, using the API server implementation, language-independent server methods describing behavior of atomic activities of a mock server based on the tokenized API package and the denormalized test case.

At step 310, the computing platform may receive a mock service template indicating an execution structure of a mock service. The mock server template may include structure and configurations of a mock service at runtime.

At step 312, the computing platform may generate the mock service using the mock service template and the generated language-independent server methods.

At step 314, the computing platform may verify the mock service by executing the API test cases against the mock service. In some examples, the computing platform may modify the mock service by adjusting configurations of programs or prompts. For example, the computing platform may correct server and client code until API test cases do not fail (e.g., because it is misconfigured or there is an error in the integration).

At step 316, in some embodiments, the computing platform may generate an integration client in a target programming language matching the generated mock service. In addition, the computing platform may verify the integration client by testing the integration client against an original service.

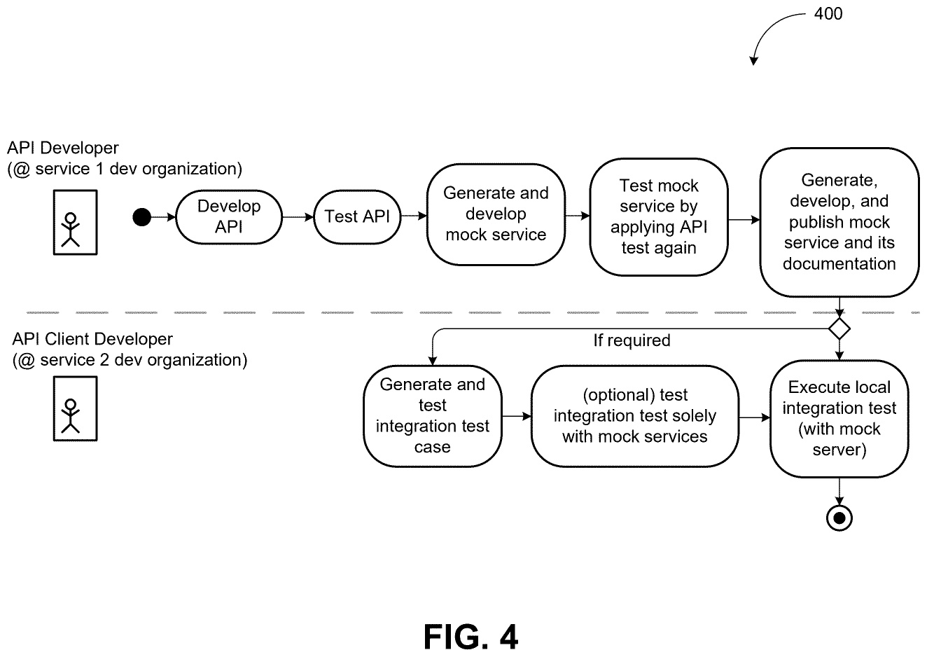

FIG. 4 depicts a flowchart illustrating a process for implementing generation of mock objects for integration testing in accordance with some example embodiments. More specifically, FIG. 4 depicts a high level lifecycle of an integration mock service. Referring to FIG. 4, an API developer generates and develops the mock service that matches the API(s) under development. The API client developer (the other partner of the integration) consumes the mock service in order to test against the mock server from the API developer. The developers belong to different organizations who develop the partners of the integration (i.e., service 1 and service 2).

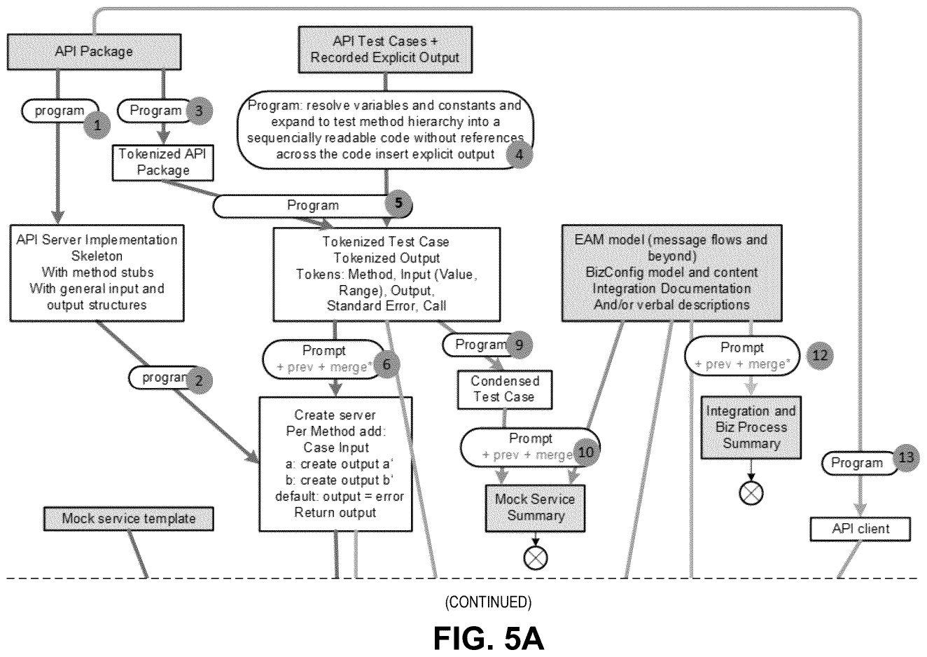

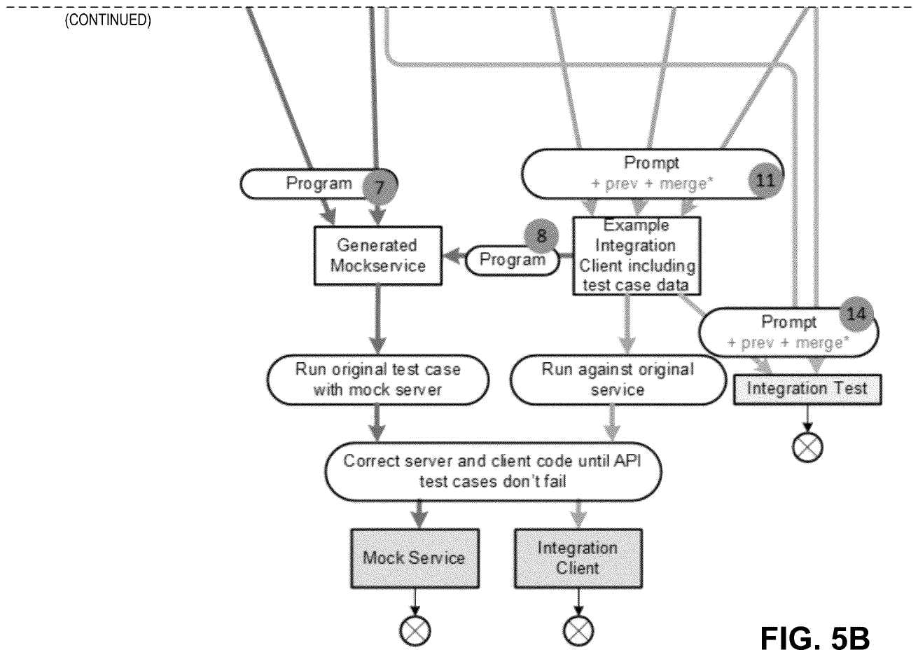

FIGS. 5A-5B depict a more detailed flowchart illustrating a process for implementing generation of mock objects for integration testing in accordance with some example embodiments. In FIGS. 5A-5B, the staged development process and the tools (executed programs or prompts) are described by several flows along the development activities. The activities shown may be implemented by a respective generation program or by generative artificial intelligence (GenAI) prompts. Prompts may also be replaced by a combination of programs and manual activities. The depicted programs and prompts may be implemented as one GenAI agent or tool that is used throughout the entire process. Whether single programs/prompts or one aggregated tool/agent is used, is an implementation detail that may be contemplated without departing from the scope of the present disclosure.

An example mock service development flow is depicted in FIGS. 5A-5B as follows:
(1) A program reads the API package (containing the API description (i.e., API calls expressed by http verbs, uniform resource identifiers (URIs), input/output data structures, error responses) and translates the API description to the API Server Implementation Skeleton. The skeleton includes API server method stubs corresponding to the different API calls specified in the API description. The method stubs are in the target mock server programming language (e.g., Java) and target mock server runtime.
(2) A program receives the method stubs and merges them into one API server (i.e., one java class or structure required by target runtime of the mock server).
(3) A program reads the API package and tokenizes the package suitable as input for a subsequent test case tokenization step.
(4) A program reads the API test cases (e.g., test code in a programming language) and recorded API output (i.e., the API call responses received during the tests, e.g., represented as JavaScript Object Notation (JSON) files) and replaces all variables and constants by their values. External references are removed, internal references (reuse-methods) are re-inserted (duplicated), and duplicate API calls with the same values are removed. The result is a “denormalized”representation of the test case.
(5) A program merges the tokenized API package and the denormalized test case representation to a set of tokens describing the API server and mock service behavior. The result is a machine-readable, programming-language-independent representation of the calls to the API corresponding to the structure of the API (based on the tokenized API package). Essentially, this is a set of programming language-independent method bodies associated with specific URIs with concrete expected inputs and the corresponding outputs to be returned by the mock service. Within a specific method corresponding to the URI, different inputs lead to corresponding and potentially different outputs.
(6) A GenAI prompt translates the tokenized test cases to API server code for a specific programming language (e.g. Java) and mock server runtime. In some cases, if the mock service already exists for a previous version of the service, the prompt will also receive the previous version of the tokenized test cases and only code needs to be generated for the differences and previously generated code and newly generated code are then merged.
(7) A program takes the mock service template and the generated server methods and generates the mock service. The mock service template encompasses all structures and configurations required by the chosen mock service runtime and indicates where the previously generated server methods have to be inserted.
(8) Optionally, a program receiving the generated example client is used to verify the mock server so that every call of the example client has a URI and method counterpart in the server and input and output structures match. This can be achieved by code analysis and/or by running the client against the server and check for errors.

Consequently, a runnable mock server of the service is made available. In order to test its correctness, the mock server may be run against the original test cases. If it passes, the mock service can be released. Otherwise, corrections are applied by rerunning previous steps with adjusted configurations of the programs or prompts.

In some embodiments, as depicted in FIG. 5A, a mock service summary development flow may proceed as follows:
(9) A program further condenses the tokenized test cases by removing, for example, the concrete output and input values.
(10) Based on the condensed test case and existing documentation, a prompt generates a technical summary of the mock service (e.g., which calls and error scenarios are supported, which URIs are used, which business configuration and master data is implied and reflected in inputs and outputs). Existing documentation encompasses, for example, message and process flows from the Enterprise Architecture Methodology (EAM) models, or integration documentation for customers.

In some embodiments, as depicted in FIGS. 5A-5B, an integration client development flow may proceed as follows:
(13) A program can be used to create a generic API client from the API packages.
(11) A prompt creates an example integration client in a target programming language matching the generated mock service. Existing documentation and the tokenized test cases may be used to generate specific methods using the generic API client for specific inputs and specific expected outputs of the mock server. Subsequently, the generated example integration client may be tested against the original service to ensure correctness of the client.

In some embodiments, as depicted in FIG. 5B, an integration test development flow may proceed as follows:
(14) A prompt receives the example client and the created server methods and the available documentation and generates at least a part of a holistic integration test case. If the other partner of the integration also provides a mock service (and thus the same set of inputs), the entire test case can be constructed. Particularly, the message flows reflect the sequence and directions of interactions between clients and servers participating in the integration and thus the business process.

In some embodiments, as depicted in FIG. 5A, an integration test development flow may proceed as follows:
(12) Similar to (10) for the mock service summary, a prompt generates an integration and business process summary. Since it does not take any test case related input, the summary is general and may serve as generic business context for developers using the mock service.

In some embodiments, each API may be tested more than once (in the above sequence) with the same test case(s) with the real service and with the generated mock service.

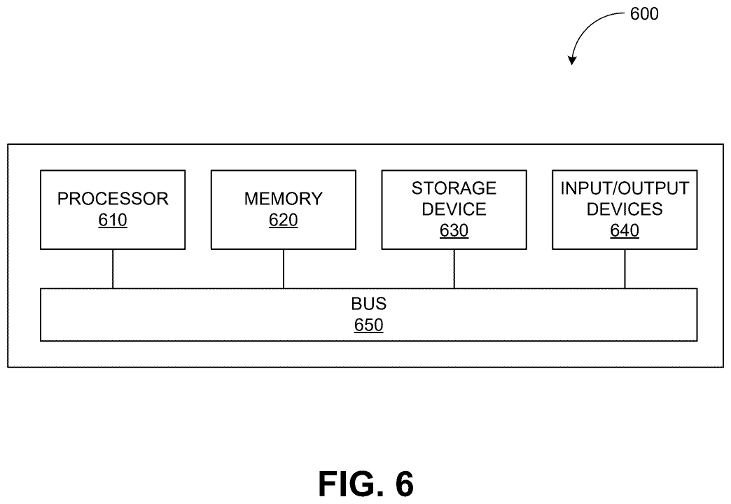

FIG. 6 depicts a block diagram illustrating a computing system 600 consistent with implementations of the current subject matter. Referring to FIGS. 1-6, the computing system 600 can be used to implement mock objects generation for integration testing 300 and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, mock objects generation for integration testing 300. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a solid-state device, a floppy disk device, a hard disk device, an optical disk device, a tape device, and/or any other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

### EXAMPLE 1

A computer-implemented method comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

### EXAMPLE 2

The computer-implemented method of Example 1, wherein the API output data comprises API call responses persisted to a file.

### EXAMPLE 3

The computer-implemented method of any of Examples 1-2, wherein the API test cases comprise test code in a programming language.

### EXAMPLE 4

The computer-implemented of any of Examples 1-3, wherein the API test cases are developed locally via a local test setup for individual testing of an API exposed by a service.

### EXAMPLE 5

The computer-implemented of any of Examples 1-4, wherein the mock service template comprises structure and configurations of a mock service at runtime.

### EXAMPLE 6

The computer-implemented of any of Examples 1-5, further comprising: generating an integration client in a target programming language matching the generated mock service; and verifying the integration client by testing the integration client against an original service.

### EXAMPLE 7

The computer-implemented of any of Examples 1-6, further comprising: modifying the mock service by adjusting configurations of programs or prompts.

### EXAMPLE 8

A system comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

### EXAMPLE 9

The system of Example 8, wherein the API output data comprises API call responses persisted to a file.

### EXAMPLE 10

The system of any of Examples 8-9, wherein the API test cases comprise test code in a programming language.

### EXAMPLE 11

The system of any of Examples 8-10, wherein the API test cases are developed locally via a local test setup for individual testing of an API exposed by a service.

### EXAMPLE 12

The system of any of Examples 8-11, wherein the mock service template comprises structure and configurations of a mock service at runtime.

### EXAMPLE 13

The system of any of Examples 8-12, the operations further comprising: generating an integration client in a target programming language matching the generated mock service; and verifying the integration client by testing the integration client against an original service.

### EXAMPLE 14

The system of any of Examples 8-13, the operations further comprising: modifying the mock service by adjusting configurations of programs or prompts.

### EXAMPLE 15

A non-transitory computer-readable storage medium including program code which when executed by at least one processor causes operations comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

### EXAMPLE 16

The non-transitory computer-readable storage medium of Example 15, wherein the API output data comprises API call responses persisted to a file.

### EXAMPLE 17

The non-transitory computer-readable storage medium of Example 15-16, wherein the API test cases comprise test code in a programming language.

### EXAMPLE 18

The non-transitory computer-readable storage medium of Example 15-17, wherein the API test cases are developed locally via a local test setup for individual testing of an API exposed by a service.

### EXAMPLE 19

The non-transitory computer-readable storage medium of Example 15-18, wherein the mock service template comprises structure and configurations of a mock service at runtime.

### EXAMPLE 20

The non-transitory computer-readable storage medium of Example 15-19, the operations further comprising: generating an integration client in a target programming language matching the generated mock service; and verifying the integration client by testing the integration client against an original service.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A computer-implemented method comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

2. The computer-implemented method of claim 1, wherein the API output data comprises API call responses persisted to a file.

3. The computer-implemented method of claim 1, wherein the API test cases comprise test code in a programming language.

4. The computer-implemented method of claim 1, wherein the API test cases are developed locally via a local test setup for individual testing of an API exposed by a service.

5. The computer-implemented method of claim 1, wherein the mock service template comprises structure and configurations of a mock service at runtime.

6. The computer-implemented method of claim 1, further comprising:
generating an integration client in a target programming language matching the generated mock service; and
verifying the integration client by testing the integration client against an original service.

7. The computer-implemented method of claim 1, further comprising:
modifying the mock service by adjusting configurations of programs or prompts.

8. A system comprising:
at least one processor; and
at least one memory including program code which when executed causes the system to provide operations comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

9. The system of claim 8, wherein the API output data comprises API call responses persisted to a file.

10. The system of claim 8, wherein the API test cases comprise test code in a programming language.

11. The system of claim 8, wherein the API test cases are developed locally via a local test setup for individual testing of an API exposed by a service.

12. The system of claim 8, wherein the mock service template comprises structure and configurations of a mock service at runtime.

13. The system of claim 8, the operations further comprising:
generating an integration client in a target programming language matching the generated mock service; and
verifying the integration client by testing the integration client against an original service.

14. The system of claim 8, the operations further comprising:
modifying the mock service by adjusting configurations of programs or prompts.

15. A non-transitory computer-readable storage medium including program code which when executed by at least one processor causes operations comprising:
receiving an application programming interface (API) package, wherein the API package comprises description data in machine-readable structure corresponding to APIs that are subject to an integration;
generating an API server implementation based on the API package;
tokenizing the API package, wherein the tokenizing comprises identifying, in a structured manner, method calls, input parameters, and output parameters;
receiving API test cases and associated API output data;
generating a denormalized test case by replacing variables and constants by their values;
generating, using the API server implementation, language-independent server methods describing behavior of atomic activities of a mock server based on the tokenized API package and the denormalized test case;
receiving a mock service template indicating an execution structure of a mock service;
generating the mock service using the mock service template and the generated language-independent server methods; and
verifying the mock service by executing the API test cases against the mock service.

16. The non-transitory computer-readable storage medium of claim 15, wherein the API output data comprises API call responses persisted to a file.

17. The non-transitory computer-readable storage medium of claim 15, wherein the API test cases comprise test code in a programming language.

18. The non-transitory computer-readable storage medium of claim 15, wherein the API test cases are developed locally via a local test setup for individual testing of an API exposed by a service.

19. The non-transitory computer-readable storage medium of claim 15, wherein the mock service template comprises structure and configurations of a mock service at runtime.

20. The non-transitory computer-readable storage medium of claim 15, the operations further comprising:
generating an integration client in a target programming language matching the generated mock service; and
verifying the integration client by testing the integration client against an original service.
